(19) United States
(12) Patent Application Publication
(10) Pub. No.: US 2018/0374333 A1
(43) Pub. Date: Dec. 27, 2018

(54) Autonomous Cloud-Based Third Party Monitoring

(71) Applicant: Roderick Andrew Coles, Colorado Springs, CO (US)

(72) Inventor: Roderick Andrew Coles, Colorado Springs, CO (US)

(21) Appl. No.: 15/630,116

(22) Filed: Jun. 22, 2017

(51) Int. Cl. G08B 25/00; H04L 29/08; G08B 25/14; H04M 11/04

(52) U.S. Cl. CPC G08B 25/009; H04L 67/10; G06F 3/0484; H04M 11/04; G08B 25/14

(57) ABSTRACT

An autonomous alarm monitoring system within the cloud contains all of a dealer's accounts. The dealers autonomous monitoring system interfaces with a third-party central station's system, and provides dealers with the ability to control all their own accounts as well as have them monitored by any third-party central station that interfaces to the dealer's autonomous alarm monitoring system. The dealer can switch from one third-party central station to any other third-party central station with a single mouse click. The dealer can split their accounts over a number of different third-party central stations and determine which types of alarm conditions or trigger signals will be sent to each third-party central station, and at what times of the day or days of the week.

### BACKGROUND

The invention is in the alarm monitoring technical field, where sensors of various types are positioned in a home or commercial property, and signals from those sensors are sent to a monitoring station to secure the safety and protection of the property and people located on the property. A customer will typically enter into a contract with an alarm installation company, referred to as a dealer, to provide a security system, a smart home system, or additional services that are monitored for a variety of alarm and signal conditions. Examples of such alarm and signal conditions include, but are not limited to, burglary, intrusion, fire, carbon monoxide, heat, freeze, water, arming, disarming, open, close, etc. Dealers typically contract with a third-party central station that is an alarm monitoring center that monitors the alarms for the dealers.

### SUMMARY

This Summary is provided to introduce in a simplified form a selection of concepts that are further described below in the Detailed Description. This Summary is not intended to identify key or essential features of the claimed subject matter, nor is it intended to be used to limit the scope of the claimed subject matter.

A contract between the customer and the dealer for monitoring services is called an account of the dealer. A dealer can move their accounts to any third-party central station which monitors the alarms and signals received from the customer's monitoring system. In prior art practice, all third-party central stations have the dealer's accounts within their own database(s) for monitoring alarms and signals. A dealer could also be a commercial entity such as a large retail chain, a school or university, government entity, or anyone that has multiple accounts that wants a third-party central monitoring station to monitor signals and alarms for it. A third-party central station may have tens of thousands to millions of accounts for multiple dealers. Dealers typically utilize third-party central stations for their accounts rather than monitor their accounts themselves, because it has traditionally been very expensive to setup and run a central station to monitor alarms and signals.

In prior art operations, a third-party central station typically has all of their dealer's accounts within their own database(s), and they allow the dealers to manage their accounts remotely. But if a dealer wishes to change the third-party central station, it is a very cumbersome ordeal. Data must be collected from the current third-party central station and then converted to another system. This is not always done in a cooperative way, because a third-party central station doesn't want to lose the business with the dealer. Additionally, phone lines and IP data (Internet Protocol—i.e., signals sent over the internet using TCP/IP or UDP/IP or on the cellular network as GPRS) must then be pointed to the new third-party central station, and all coordinated with the data going live. The costs involved, and the pain to both the third-party central station, the dealer, and the customer are obvious in this scenario. Clearly, the dealer is at the mercy of the current third-party central station, and with respect to what facilities and services the third-party central station provides, and even whether the third-party central station keeps up with new or changing technology, or fails to do so.

What is needed in the art is a more robust, cheaper, and more efficient and less cumbersome way to monitor the accounts and to be able to move the accounts easily between third-party central stations.

The detailed description below describes creating an autonomous alarm monitoring system within the cloud that contains all the dealer's accounts but interfaces with third-party central stations systems, and provides dealers with the ability to control all their own accounts as well as have them monitored by any third-party central station that interfaces to the technology. Described below is an autonomous cloud-based third-party monitoring solution.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

It is to be noted that the term “a entity” or “an entity” refers to one or more of that entity. As such, the terms “a” (or “an”), “one or more,” and “at least one” can be used interchangeably herein. It is also to be noted that the terms “comprising,” “including,” and “having” can be used interchangeably.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof, shall include all those described in the summary of the invention, brief description of the drawings, detailed description, abstract, and claims themselves.

Unless the meaning is clearly to the contrary, all ranges set forth herein are deemed to be inclusive of the endpoints.

The term “Signal” means an electronic event sent from the Customer's Alarm System. It may be transmitted over various media, such as phone lines, cellular system, GPRS, TCPIP, UDPIP, SMS, email, other IP (Internet Protocols), etc. The format may vary as well. A Signal is essentially telling the Alarm Monitoring Software that something has changed. Additionally, the Alarm Monitoring Software can generate is own Signal when a Signal has not been received from the Customer's equipment when one was expected. For example, if a Customer was due to close their office at a specified time and a close Signal was not received, the Alarm Monitoring Software may generate a “Late to Close” Signal.

The term “Alarm” means that a Signal is elevated by the Autonomous Alarm Monitoring System because certain triggering conditions have been met. Certain Signals, such as fire Signals and intrusion Signals are nearly always elevated to an Alarm. Other Signals may get elevated to an Alarm based on time of day or other predefined criteria. Sometimes a Customer's Alarm System is placed on test so a technician can work on the system. In this scenario, a Signal would not get elevated to an Alarm. Generally, a Signal is just logged for audit purposes but an Alarm is escalated so that Customers, authorities (police, fire, medical, etc.), guards, or other responding entities can be notified.

The term “Alarm System” means a security system, or a smart home system, or additional alert services installed at a location.

The term “Alarm Monitoring Software” means the software that is running in the Autonomous Alarm Monitoring System in the Cloud that is accessed by the Third-Party Central Station for Third-Party Central Station monitoring, and is accessed by the Dealer to manage his Dealer Accounts.

The term “Communication Channel” means a wired, wireless, or a combination of wired and wireless communications links now available or later developed that connect one electronic system to another electronic system.

The term “Dealer” means an Alarm System installation company, or any other entity that has multiple Dealer Accounts that it desires a Third-Party Central Station to monitor.

The term “Customer” means the person or entity, or the site, for whom or for where the Dealer has installed an Alarm System.

The term “Dealer Account” means a Customer secured by the Dealer.

The term “Third-Party Central Station” means an entity that monitors Alarms and Signals for a Dealer and the Dealer's Customers.

The term “Cloud” means a network of remote servers hosted on the Internet to store, manage, and process data, rather than a local server or a personal computer.

The term “Autonomous Alarm Monitoring System” means an independent monitoring system in the Cloud that the Dealer can manage his Dealer Accounts on, and that will forward Signals and Meta-Data Alarms to a Third-Party Central Station.

The term “Meta-Data Alarm” means an Alarm in the Dealer's Cloud-based Autonomous Alarm Monitoring System that contains enough information, or meta-data, to allow the Third-Party Central Station to connect securely back to the Autonomous Alarm Monitoring System and handle the Alarm.

The term “Alarm Queue” means a list/queue/buffer of Alarms that are usually ordered by priority, i.e., the importance of the Alarm. Usually fire is highest priority, then personal attack, then burglary etc.), then by date and/or time. Third-Party Central Stations typically define the priority of Alarms, but the Customers may also order the priority of Alarms by other criteria if they so choose.

The term “UL Alarm” means an Alarm from a UL certified installation to a UL certified Third-Party Central Station.

The term “non-UL Alarm” means an Alarm that doesn't meet the UL Alarm standards.

### BRIEF DESCRIPTION OF THE SEVERAL VIEWS OF THE DRAWINGS

FIG. 1 shows a traditional third-party central station model of alarm monitoring known in the prior art.

FIG. 2 shows an autonomous cloud-based monitoring model of alarm monitoring in an embodiment of the present invention.

FIG. 3 shows the overall flow of an embodiment of autonomous cloud-based monitoring of the present invention.

### DETAILED DESCRIPTION

The invention may be implemented as a computer process, a computing system or as an article of manufacture such as a computer program product. The computer program product may be a computer storage medium readable by a computer system and encoding a computer program of instructions for executing a computer process.

The invention may also be practiced as a method, or more specifically as a method of operating a computer system. Such a system would include appropriate program means for executing the method of the invention. With the computing environment in mind, embodiments of the present invention are described with reference to logical operations being performed to implement processes embodying various embodiments of the present invention. These logical operations are implemented (1) as a sequence of computer implemented steps or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts, applications, or modules. It will be recognized by one skilled in the art that these operations, structural devices, acts, applications, and modules may be implemented in software, firmware, special purpose digital logic, and any combination thereof without deviating from the spirit and scope of the present invention as recited within the claims attached hereto.

Referring now to the Figures, like reference numerals and names refer to structurally and/or functionally similar elements thereof, and if objects depicted in the figures that are covered by another object, as well as the tag line for the element number thereto, may be shown in dashed lines.

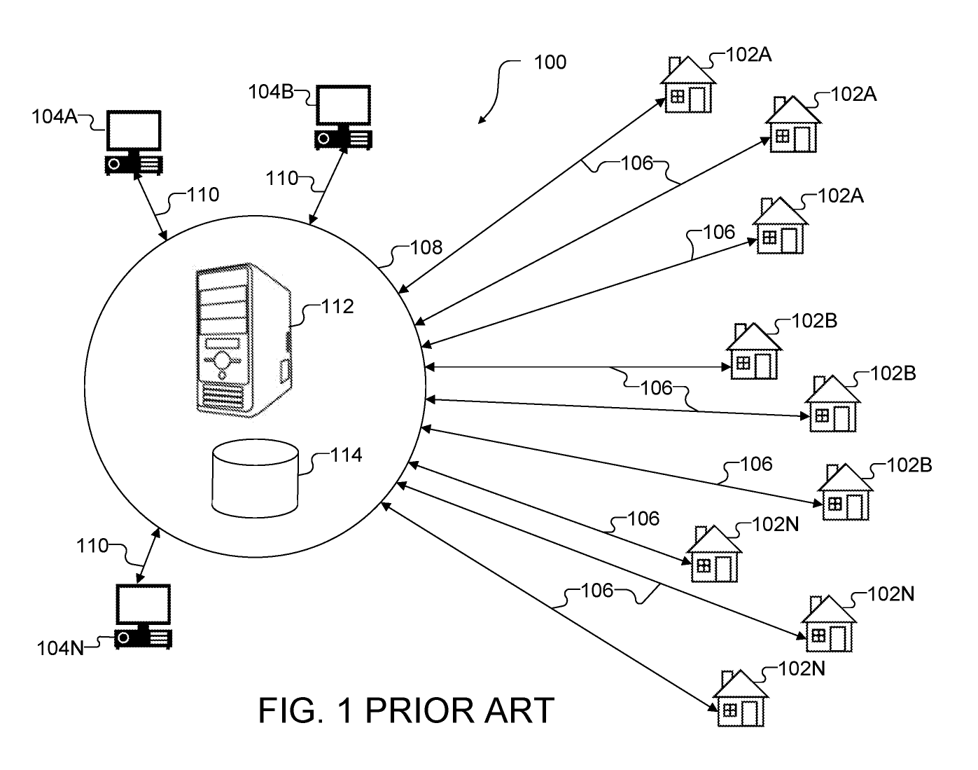

FIG. 1 shows a traditional third-party central station model of alarm monitoring known in the prior art. Referring now to FIG. 1, Third-Party Central Station Model 100 has numerous Customers 102A, 102B, and 102N that contract with Dealers 104A, 104B, and 104N for installation and alarm monitoring services. Dealers 104A/B/N typically install some type of a security system, or a smart home system, or additional services (collectively referred to as an Alarm System) desired by the Customers 102A/B/N. Signals and Alarms are sent from the Customers 102A/B/N through Communication Channel 106 to a Third-Party Central Station 108 where the Alarms are handled and closed out. Communication Channels 106 may also be wired, wireless, or a combination of wired and wireless communications links now available or later developed. Third-Party Central Station 108 may receive Alarms from Customers of the same or a different Dealer 104A/B/N. Handling the Alarm may involve calling the police, or fire department, or ambulance service or other interested party to respond or even go to the Customer 102A/B/N location, calling a predesignated third-party, sending a return signal to the Customer 102A/B/N location to activate or deactivate a device or monitor, etc. Though only one Third-Party Central Station 108 is shown in FIG. 1, there are many other Third-Party Central Stations 108 located in various locations around the country. Within each Third-Party Central Station 108 is at least one Server 112 to handle and process the Signals and Alarms and at least one Database 114 that has all of their Dealer 104A/B/N account information on each of the Customers 102A/B/N. Each Third-Party Central Station 108 may have tens of thousands to millions of accounts of Customers 102A/B/N for multiple Dealers 104A/B/N. Dealers 104A/B/N also access Third-Party Central Station 108 through Communication Channels 110 which may also be wired, wireless, or a combination of wired and wireless communications links now available or later developed.

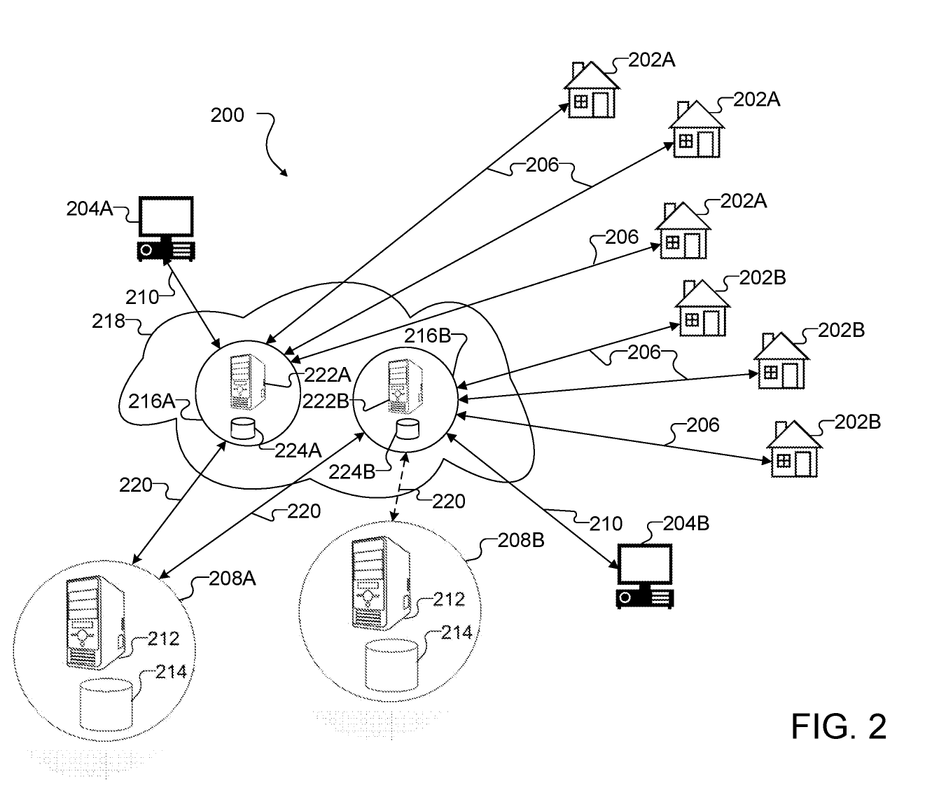

FIG. 2 shows an autonomous cloud-based third-party monitoring system for alarm monitoring in an embodiment of the present invention. Referring now to FIG. 2, Autonomous Cloud-Based Monitoring Model 200 has numerous Customers 202A, 202B, and 202N that contract with Dealers 204A, 204B, and 204N for installation and alarm monitoring services (Customer 202N and Dealer 204N are not shown in FIG. 2 for clarity but are comparable to Customer 102N and Dealer 104N as shown in FIG. 1). Dealers 204A/B/N typically install some type of a security system, or a smart home system, or additional alert services (collectively referred to as an Alarm System) desired by the Customers 202A/B/N. Signals and Alarms from the Customers 202A/B/N Alarm System are sent from the Customers 202A/B/N through Communication Channels 206 to an Autonomous Alarm Monitoring System 216A and 216B (and 216N, not shown in FIG. 2) located in the Cloud 218. Within each Autonomous Alarm Monitoring System 216A/B/N is at least one Server 222A/B/N to handle and process the Signals and Alarms and at least one Database 224A/B/N. that has all of their Dealer 204A/B/N account information on each of the Customers 202A/B/N. All of the Dealer's 204A/B/N Dealer Accounts are stored in the Database 224A/B/N in the Autonomous Alarm Monitoring System 216A/B/N in the Cloud 218 and are accessible by the Dealer's 204A/B/N through Communication Channels 210. Autonomous Alarm Monitoring System 216A/B/N gives each Dealer 204A/B/N a complete business solution and total control and ownership of their accounts. Communication Channels 206 and Communication Channels 210 may be wired, wireless, or a combination of wired and wireless communications links now available or later developed.

Autonomous Cloud-Based Monitoring Model 200 works by allowing Third-Party Central Stations 208A and 208B (and 208N, not shown in FIG. 2) to couple with the Dealer's 204A/B/N Cloud-based Autonomous Alarm Monitoring System 216A/B/N, to provide the same services as they would if the data were all within the Third-Party Central Station 208A/B/N alarm monitoring system. Within each Third-Party Central Station 208A/B/N is at least one Server 212 to handle and process the Signals and Alarms and at least one Database 214 for All of the Customers 202A/B/N Signals and Alarms will come into the Cloud-based Autonomous Alarm Monitoring System 216A/B/N. Alarms will forward to one or many designated Third-Party Central Stations 208A/B/N as a new “Meta-Data Alarm” over Communication Channels 220. Signals may also be forwarded to one or many designated Third-Party Central Stations 208A/B/N. Communication Channels 220 may also be wired, wireless, or a combination of wired and wireless links now available or later developed. The Meta-Data Alarms do not arrive via signaling or traditional receiver equipment. They are not processed or decoded at all by the Third-Party Central Station 208A/B/N monitoring system, but are put straight into an Alarm Queue. This is because the Alarm will not actually be processed on the Third-Party Central Station 208A/B/N system. Instead, the Alarm is handled in the Dealer's 204A/B/N Autonomous Alarm Monitoring System 216A/B/N. When the operator at the Third-Party Central Station 208A/B/N picks up the Alarm, it contains enough meta-data to enable the Third-Party Central Station 208A/B/N system to securely connect back to the Dealer's 204A/B/N Autonomous Alarm Monitoring System 216A/B/N. This is accomplished by using web browser technology to connect to an Alarm Handling User Interface (UI) within the Dealer's 204A/B/N Autonomous Alarm Monitoring System 216A/B/N. Although completely transparent to the operator, the operator is now working on the Dealer's 204A/B/N Autonomous Alarm Monitoring System 216A/B/N, and not on the Third-Party Central Station 208A/B/N system. Some details of the Meta-Data Alarms will be kept in the Third-Party Central Station 208A/B/N system so that an audit and checks and balances can be maintained, but no information that would be considered owned by the Dealers 204A/B/N (i.e., names of Customers, addresses, phone numbers, etc.). Unless specific permission was given, the Third-Party Central Station 208A/B/N cannot get access to the Dealer's 204A/B/N data other than what is visible because of an Alarm situation.

From this point on everything is done on the Dealer's 204A/B/N Autonomous Alarm Monitoring System 216A/B/N in the Cloud 218. When the Alarm is closed out the operator is disconnected from the Dealer's 204A/B/N Autonomous Alarm Monitoring System 216A/B/N, and the next Alarm is processed as described above.

The most obvious advantage of Autonomous Cloud-Based Monitoring Model 200 is the Dealers 204A/B/N can switch to another Third-Party Central Station 208A/B/N with a single mouse click. For example, in FIG. 2 Dealer 204B is utilizing Third-Party Central Station 208A in conjunction with Autonomous Alarm Monitoring System 216B. With a single click, Dealer 204B can select Third-Party Central Station 208B to work with Autonomous Alarm Monitoring System 216B over Communication Channel 220 shown in dashed line. Clearly, this has some very real economic advantages, but it could also be a great asset in case of emergency conditions, such as technical issues at the current Third-Party Central Station 208A/B/N or storm conditions affecting their service. The Dealer 204A/B/N could even take over the monitoring themselves, if they decided that was what they wanted to do. This presents another possibility where the Dealer 204A/B/N wants to monitor Alarms during the day or weekday, but wants a Third-Party Central Station 208A/B/N to monitor at all other times. Taking one more step, the Dealer 204A/B/N could also split the Alarms into various groups and deliver them to one or more Third-Party Central Stations 208A/B/N or handle them themselves. So, fire, burglary, and other emergency Alarms could go to a Third-Party Central Station 208A/B/N and social or low priority Alarms could be handled by the Dealer 204A/B/N themselves. Another example could be UL Alarms go to a Third-Party Central Station 208A/B/N and non-UL Alarms are handled by the Dealer 204A/B/N themselves or even a lower priced non-UL certified Third-Party Central Station 208A/B/N. The system could even create a new paradigm of pay-as-you-go third-party monitoring. Where Alarms are delivered to multiple Third-Party Central Stations at the same time, whomever handles the Alarm first is the one that is paid for the event. There are also advantages to the Third-Party Central Stations 208A/B/N, as they can take on new Dealers without having to increase their own infrastructure as the Dealer is in the Cloud, so they don't need to spend money on additional software licenses, phone lines, data bandwidth, receiver capacity, data conversion etc.

In the prior art system shown in FIG. 1, Dealers 104A/B/N often pushed Third-Party Central Stations 108 to adopt certain new technologies. As an example, a dealer may want to use OpenEye, an online video management platform, but if the Third-Party Central Stations 108 hadn't purchased OpenEye, the Dealer was out of luck. That issue goes away with Autonomous Cloud-Based Monitoring Model 200, because the Dealer 204A/B/N could purchase the OpenEye integration for their Autonomous Alarm Monitoring System 216A/B/N and it would be immediately available to the Third-Party Central Station 208A/B/N. Of course, training is a consideration here, but the Dealer 204A/B/N might contract those specific accounts out to a Third-Party Central Station 208A/B/N that is more experienced with OpenEye. Splitting their Customer accounts across multiple Third-Party Central Stations 208A/B/N is easy to accomplish with Autonomous Cloud-Based Monitoring Model 200.

As Autonomous Cloud-Based Monitoring Model 200 is embraced, over time any given Third-Party Central Station 208A/B/N could eventually have no accounts within their system but be monitoring many Customers 202A/B/N using the Dealer's 204A/B/N Autonomous Alarm Monitoring System 216A/B/N. Additionally, because of the reduced overhead, smaller Third-Party Central Stations 208A/B/N could emerge because the cost of starting the business and the size required to sustain a business would be reduced.

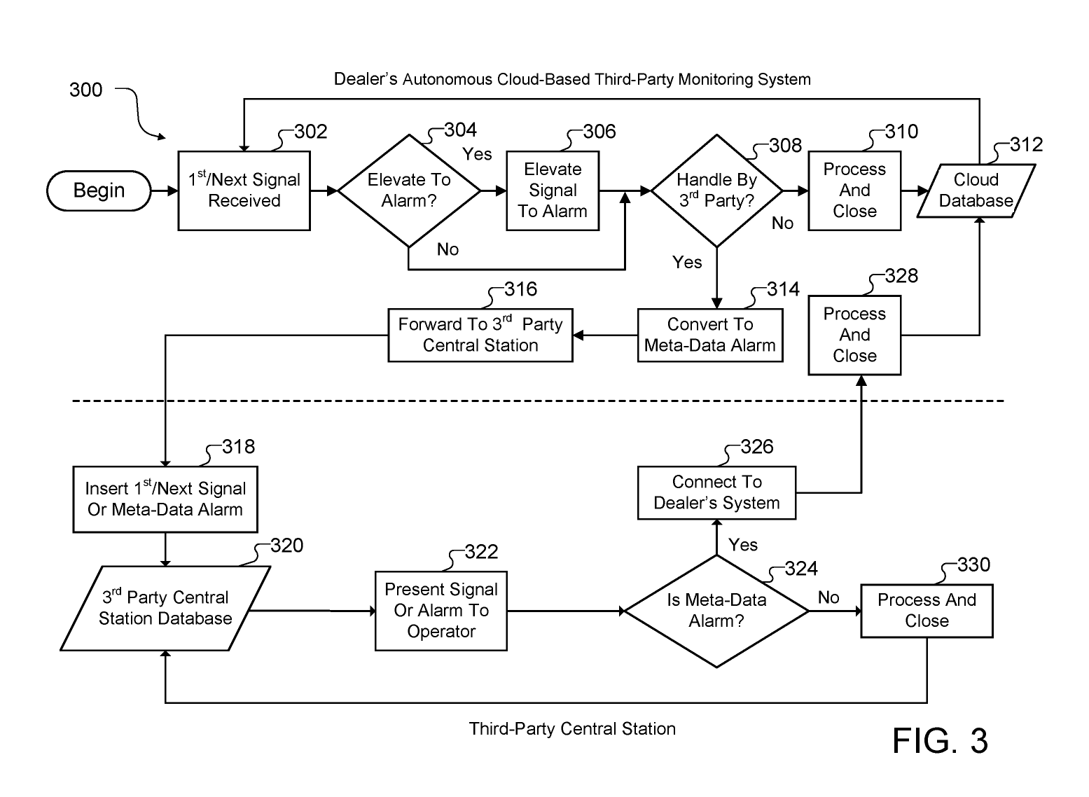

FIG. 3 shows the overall flow of an embodiment of an autonomous cloud-based third-party monitoring system for alarm monitoring of the present invention. Referring now to FIG. 3, the method 300 begins in block 302 when a Signal is received in a Dealer's 204A/B/N Autonomous Alarm Monitoring System 216A/B/N from a Customer 202A/B/N Alarm System. Block 304 determines if the Signal needs to be elevated to an Alarm if certain triggering conditions have been met according to the predetermined order of priority. If no, the Signal is passed on as received to decision block 304. If yes, in block 306 the Signal is Elevated to an Alarm by Autonomous Alarm Monitoring System 216A/B/N. Block 308 determines if the Signal or Alarm is to be handled by Third-Party Central Stations 208A/B/N. If no, the Signal or Alarm is handled by Autonomous Alarm Monitoring System 216A/B/N in block 310. The Signal or Alarm is processed in any of the ways previously described above and in block 312 is stored in the Cloud Database of Autonomous Alarm Monitoring System 216A/B/N. Control then returns to block 302 to receive the next Signal.

If block 308 determines that the Signal or Alarm is to be handled by Third-Party Central Stations 208A/B/N, then in block 314 the Alarm is converted to a Meta-Data Alarm, and in block 316 the Signal or the Meta-Data Alarm are forwarded to a Third-Party Central Station 208A/B/N. In block 318 the Signal or the Meta-Data Alarm is inserted into the Alarm Queue. In block 320 the. In block 322 the Signal or the Meta-Data Alarm at the top of the Alarm Queue is presented to the operator at the Third-Party Central Station 208A/B/N. Block 324 determines if there is a Meta-Data Alarm. If yes, then block 326 connects the operator to the Dealer's 204A/B/N Autonomous Alarm Monitoring System 216A/B/N using web browser technology to connect to an Alarm Handling User Interface (UI) within the Dealer's 204A/B/N Autonomous Alarm Monitoring System 216A/B/N. The operator at Third-Party Central Station 208A/B/N in block 328, utilizing the Dealer's 204A/B/N Autonomous Alarm Monitoring System 216A/B/N, processes the Alarm condition and closes it. In block 312 the Alarm condition as processed is stored in the Cloud database. Control then returns to block 302 where the next Signal or Alarm is received.

If block 324 determines that there is a Signal and not a Meta-Data Alarm, the operator in block 330 processes and closes out the Signal and the Signal as processed is stored in block 320 in the database in Third-Party Central Station 208A/B/N, where the next Signal or Alarm can then be processed.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It will be understood by those skilled in the art that many changes in construction and circuitry and widely differing embodiments and applications will suggest themselves without departing from the scope of the disclosed subject matter.

What is claimed is:

1. A method for autonomous cloud-based third-party monitoring, the method comprising the steps of:
(a) receiving, in an autonomous alarm monitoring system located in a cloud, a signal from an alarm system;
(b) elevating the signal to an alarm;
(c) converting the alarm to a meta-data alarm;
(d) forwarding the meta-data alarm to a first third-party central station;
(e) connecting the first third-party central station to the autonomous alarm monitoring system; and
(f) processing the alarm from the first third-party central station through the connection to the autonomous alarm monitoring system.

2. The method for autonomous cloud-based third-party monitoring according to claim 1, wherein step (b) further comprises the step of:
elevating the signal to an alarm when certain triggering conditions have been met.

3. The method for autonomous cloud-based third-party monitoring according to claim 2, further comprising the step of:
elevating the signal to an alarm when the signal is at least one of a fire signal, an intrusion signal, and a signal meeting a predefined criteria.

4. The method for autonomous cloud-based third-party monitoring according to claim 3, further comprising the steps of:
determining if the signal, or the alarm, is to be handled by the first third-party central station or by the autonomous alarm monitoring system;
when the signal, or the alarm, is to be handled by the autonomous alarm monitoring system:
processing the signal, or the alarm, in the autonomous alarm monitoring system; and
storing the signal, or the alarm, in a first database of the autonomous alarm monitoring system;
when the signal is to be handled by the first third-party central station:
forwarding the signal to the first third-party central station; and
when the alarm is to be handled by the first third-party central station:
converting the alarm to a meta-data alarm; and
forwarding the meta-data alarm to the first third-party central station.

5. The method for autonomous cloud-based third-party monitoring according to claim 4, further comprising the steps of:
inserting the signal, or the meta-data alarm, into an alarm queue in the first third-party central station; and
storing the signal, or the meta-data alarm, in a second database in the first third-party central station.

6. The method for autonomous cloud-based third-party monitoring according to claim 1, further comprising the steps of:
presenting the signal, or the meta-data alarm, to an operator at the first third-party central station;
when the operator is presented with the signal;
processing the signal in the first third-party central station; and
storing the signal in a second database in the first third-party central station;
when the operator is presented with the meta-data alarm:
performing step (e) and step (f); and
storing the meta-data alarm in a first database in the autonomous alarm monitoring system.

7. The method for autonomous cloud-based third-party monitoring according to claim 1, wherein step (f) further comprises the step of:
notifying a responding entity that has authority to take an action regarding the alarm.

8. The method for autonomous cloud-based third-party monitoring according to claim 1, further comprising the step of:
switching monitoring from the first third-party central station to a second third-party central station with a single mouse click.

9. The method for autonomous cloud-based third-party monitoring according to claim 8, further comprising the steps of:
splitting a plurality of alarms into a first group and into a second group;
sending the first group to the first third-party central station for monitoring; and
sending the second group to the second third-party central station for monitoring.

10. A method for autonomous cloud-based third-party monitoring, the method comprising the steps of:
(a) receiving, in an autonomous alarm monitoring system located in a cloud, a signal from an alarm system;
(b) elevating, by the autonomous alarm monitoring system, the signal to an alarm if certain triggering conditions are met;
(c) converting, by the autonomous alarm monitoring system, the alarm to a meta-data alarm;
(d) forwarding, by the autonomous alarm monitoring system, the meta-data alarm to a first third-party central station;
(e) inserting, by the first third-party central station, the meta-data alarm into an alarm queue in a server;
(f) presenting, by the server, the meta-data alarm from the alarm queue to an operator;
(g) connecting, by a web browser, the operator to the autonomous alarm monitoring system; and
(h) processing, by the operator, the alarm using the autonomous alarm monitoring system.

11. The method for autonomous cloud-based third-party monitoring according to claim 10, wherein step (b) further comprises the step of:
elevating, by the autonomous alarm monitoring system, the signal to an alarm when certain triggering conditions have been met.

12. The method for autonomous cloud-based third-party monitoring according to claim 11, further comprising the step of:
elevating, by the autonomous alarm monitoring system, the signal to an alarm when the signal is at least one of a fire signal, an intrusion signal, and a signal meeting a predefined criteria.

13. The method for autonomous cloud-based third-party monitoring according to claim 12, further comprising the steps of:
determining, by the autonomous alarm monitoring system, if the signal, or the alarm, is to be handled by the first third-party central station or by the autonomous alarm monitoring system;
when the signal, or the alarm, is to be handled by the autonomous alarm monitoring system:
processing, by the autonomous alarm monitoring system, the signal, or the alarm; and
storing, by the autonomous alarm monitoring system, the signal, or the alarm, in a first database of the autonomous alarm monitoring system;
when the signal is to be handled by the first third-party central station:
forwarding, by the autonomous alarm monitoring system, the signal to the first third-party central station; and
when the alarm is to be handled by the first third-party central station:
converting, by the autonomous alarm monitoring system, the alarm to a meta-data alarm; and
forwarding, by the autonomous alarm monitoring system, the meta-data alarm to the first third-party central station.

14. The method for autonomous cloud-based third-party monitoring according to claim 13, further comprising the steps of:
inserting, by the first third-party central station, the signal, or the meta-data alarm, into an alarm queue in the first third-party central station; and
storing, by the first third-party central station, the signal, or the meta-data alarm, in a second database in the first third-party central station.

15. The method for autonomous cloud-based third-party monitoring according to claim 10, further comprising the steps of:
presenting, by the first third-party central station, the signal, or the meta-data alarm, to an operator at the first third-party central station;
when the operator is presented with the signal;
processing, by the first third-party central station, the signal; and
storing, by the first third-party central station, the signal in a second database in the first third-party central station;
when the operator is presented with the meta-data alarm:
performing step (g) and step (h); and
storing, by the autonomous alarm monitoring system, the meta-data alarm in a first database in the autonomous alarm monitoring system.

16. The method for autonomous cloud-based third-party monitoring according to claim 10, wherein step (f) further comprises the step of:
notifying, by the autonomous alarm monitoring system, a responding entity that has authority to take an action regarding the alarm.

17. The method for autonomous cloud-based third-party monitoring according to claim 1, further comprising the step of:
switching monitoring from the first third-party central station to a second third-party central station with a single mouse click.

18. The method for autonomous cloud-based third-party monitoring according to claim 17, further comprising the steps of:
splitting a plurality of signals into a first group and into a second group;
sending the first group to the first third-party central station for monitoring; and
sending the second group to the second third-party central station for monitoring.

19. An autonomous cloud-based third-party monitoring system comprising:
an alarm system located at a customer location that sends a signal indicating a change;
an autonomous alarm monitoring system located in a cloud, the autonomous alarm monitoring system having at least one server, at least one database, an alarm monitoring software running in the server that can elevate the signal received in the autonomous alarm monitoring system to an alarm when certain triggering conditions are met, and converts the alarm to a meta-data alarm, and an alarm handling user interface running in the server;
a first third-party central station having at least one server, at least one database, a web browser running in the at least one server, and an alarm queue running in the server;
a first communication channel that allows the autonomous alarm monitoring system to receive the signal from the alarm system at the customer location; and
a second communication channel that allows the autonomous alarm monitoring system to send the signal, or the meta-data alarm, to the first third-party central station for insertion into the alarm queue, and to allow the first third-party central station through the web browser to access the alarm handling user interface in the autonomous alarm monitoring system when a meta-data alarm is received, and to process the alarm in the autonomous alarm monitoring system from the first third-party central station.

20. The autonomous cloud-based third-party monitoring system according to claim 19 wherein the web browser allows an operator at the first third-party central station to access the autonomous alarm monitoring system through first communication channel using the alarm handling user interface to process the alarm.

21. The autonomous cloud-based third-party monitoring system according to claim 19 wherein the alarm monitoring software elevates the signal to an alarm when the signal is a fire signal, an intrusion signal, and a signal meeting a predefined criteria.

22. The autonomous cloud-based third-party monitoring system according to claim 21 further comprising:
a dealer; and
a plurality of dealer accounts stored in the at least one database in the autonomous alarm monitoring system;
wherein the dealer accesses the plurality of dealer accounts through the alarm monitoring software to manage the dealer accounts.

23. The autonomous cloud-based third-party monitoring system according to claim 22 further comprising:
a second third-party central station, wherein a single mouse click switches monitoring from the first third-party central station to the second third-party central station.

24. The autonomous cloud-based third-party monitoring system according to claim 23 further comprising:
a plurality of signals split into a first group and a second group by the autonomous alarm monitoring system, wherein the first group is monitored by the first third-party central station, and the second group is monitored by the second third-party central station.

25. The autonomous cloud-based third-party monitoring system according to claim 21 further comprising:
at least one responding entity that has authority to take action when notified of the alarm.
